(19) United States
(12) Patent Application Publication
(10) Pub. No.: US 2006/0203259 A1
(43) Pub. Date: Sep. 14, 2006

(54) Index sheet, picture case, image processing apparatus, image processing method and storage medium storing program

(75) Inventor: Satoshi Usui, Nakai-machi (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 11/219,674

(22) Filed: Sep. 7, 2005

(30) Foreign Application Priority Data
Mar. 10, 2005 (JP) 2005-067603

(51) Int. Cl. G06F 3/12

(52) U.S. Cl. 358/1.1

(57) ABSTRACT

An index sheet used for checking picture prints included in a particular picture print group has: an index print area in which plural picture print images included in the particular picture print group are formed; and a heading area sharing a fold line with the index print area, in which a heading image for the particular picture print group is formed.

### BACKGROUND OF THE INVENTION

1. Field of the Invention

The present invention relates to an index sheet attached to a picture print, a picture case to contain the picture print, and an image processing apparatus to generate an index sheet image.

2. Description of the Related Art

Generally, when picture printing is ordered at a photo studio or the like, then picture prints in a slip-attached envelope are handed to a customer. The customer receives the picture prints and organizes them.

One of such organizing sections is an album. A known album has thick paper sheets. Picture prints are attached to each of the sheets. In another album, picture prints are held on adhesive films. Further, an album having thin film pockets is known. Further, recently known is an album having a clear-file type vinyl pockets for the purpose of portability and storage of picture prints.

However, as the work to organize picture prints using an album is troublesome, many picture prints are left unorganized. The use of an album is not so helpful to modern people under time constraints.

Further, generally, in an album, its paper sheets occupy a very large volume in comparison with that of picture prints. As picture prints are accumulated in many years, a very large area is required to place the albums.

Further, to find a particular picture print from organized picture prints, it is necessary to look at titles, or when no title is attached, to check the album contents. This is also troublesome.

In view of such situation, a simple picture case in which an index sheet is recognizable from outside has been proposed.

However, in this picture case, the index sheet is merely recognizable from outside. For example, when this picture case is placed on a bookshelf or the like, as the index sheet cannot be seen, the contents of the picture case are unknown until the case is taken from the bookshelf and the index sheet is checked.

Further, as the index sheet shows reduced images, the time, the event or the like in which the pictures in the case have been taken cannot be quickly obtained.

### SUMMARY OF THE INVENTION

The present invention has been made to address the above technical problems and enables a user to easily organize picture prints and easily perform a search on the organized picture prints later.

According to an embodiment of the present invention, an index sheet is used for checking picture prints included in a particular picture print group, and the index sheet comprises an index print area in which a plurality of picture print images included in the particular picture print group are formed, and the index sheet comprises a heading area sharing a fold line with the index print area, in which a heading image for the particular picture print group is formed.

According to another embodiment of the present invention, a picture case for storing picture prints comprises at least five surfaces including a first surface and a second surface adjacent to the first surface, and an index sheet having an index print area where original images of the picture prints are formed and a heading area to display heading informations for the picture prints, wherein the index sheet is attached so as to cause the index print area to be recognizable from a direction vertical to the first surface and to cause the heading area to be recognizable from a direction vertical to the second surface.

According to another embodiment of the present invention, an image processing apparatus for generating an index sheet image used for checking picture prints comprises an image acquisition unit that acquires a plurality of picture images, an information acquisition unit that acquires heading information for the plurality of picture images, and an index sheet image generation unit that generates an index sheet image having a heading by combining an index print image with a heading image so that the index print image and the heading image hold a fold line therebetween, the index print image including a predetermined number of images selected from the plurality of picture images acquired by the image acquisition unit, the heading image including the heading information acquired by the information acquisition unit.

According to another embodiment of the present invention, an image processing method for generating an index sheet image used for checking picture prints, comprises acquiring a plurality of picture images, acquiring heading informations for the plurality of picture images, and generating an index sheet image by combining an index print image including the plurality of picture images with a heading image including the heading information so that the index print image and the heading image hold a fold line therebetween.

According to another embodiment of the present invention, a storage medium that readable by a computer, the storage medium storing a program of instructions executable by the computer to perform a function, comprises acquiring a plurality of picture images, acquiring heading informations for the plurality of picture images, and generating an index sheet image by combining an index print image including the plurality of picture images with a heading image including the heading information so that the index print image and the heading image hold a fold line therebetween.

### BRIEF DESCRIPTION OF THE DRAWINGS

The above and other object, features and advantages of the present invention will become more apparent from the following detailed description when taken in conjunction with the accompanying drawings wherein:

FIG. 1 is a cross-sectional view of a first picture case according to an embodiment of the present invention;

FIG. 2 is a cross-sectional view of a second picture case according to the embodiment of the present invention;

FIG. 3A is a cross-sectional view showing a state where an index sheet is fitted in the picture case according to the embodiment of the present invention;

FIG. 3B an explanatory view showing variation of a projection provided in the picture case;

FIG. 4 is a table showing the specification of the picture case according to the embodiment of the present invention;

FIGS. 5A to 5C are examples of the index sheet according to the embodiment of the present invention;

FIG. 6 is a front view showing an external appearance of an image forming apparatus according to the embodiment of the present invention;

FIG. 7 is a block diagram showing the functional construction of a processing unit in the image forming apparatus according to the embodiment of the present invention;

FIG. 8 is a flowchart showing the operation of an input/output processor of the processing unit in the image forming apparatus according to the embodiment of the present invention;

FIG. 9 is a flowchart showing the operation of an image generator of the processing unit in the image forming apparatus according to the embodiment of the present invention;

FIG. 10 is a schematic cross-sectional view of the internal structure of an apparatus main body of the image forming apparatus according to the embodiment of the present invention; and

FIG. 11 is a perspective view showing a state where picture cases according to the embodiment of the present invention are arranged on a bookshelf.

### DETAILED DESCRIPTION OF THE INVENTION

Hereinbelow, a best mode to implement the present invention (hereinbelow, referred to as an “embodiment”) will be described in detail with reference to the attached drawings.

[Picture Case]

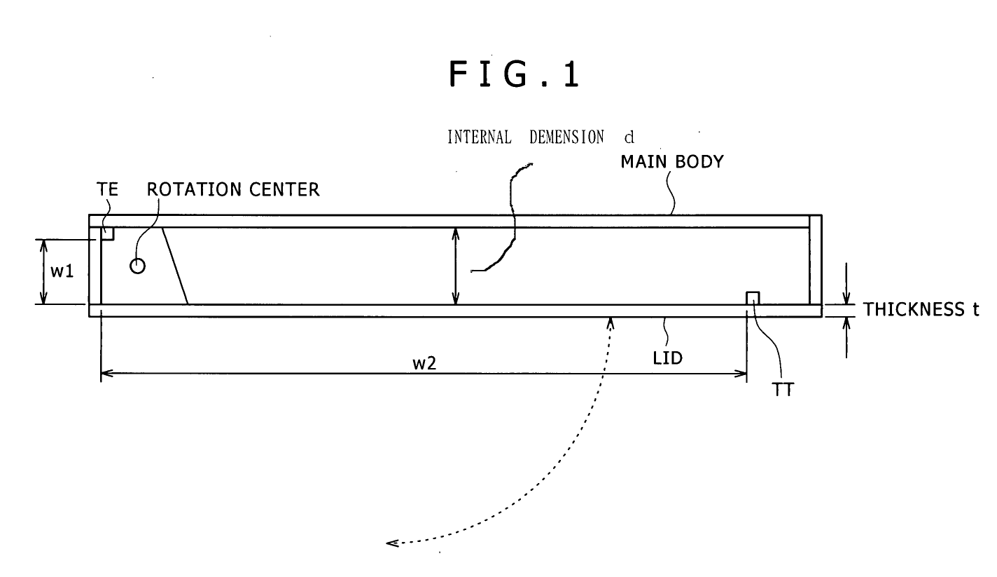

FIG. 1 is a cross-sectional view of a first picture case according to the embodiment of the present invention.

The first picture case has a supporting point (rotation center) on the opposite side to an opening as in the case of a CD (Compact Disk) case or a cassette tape case. A lid is rotated about the rotation center as indicated with a broken arrow line, thereby picture prints can be put/taken out from the case. Further, projections TE and TT to fix an index sheet are provided in an illustrated position inside the case.

Note that the following description will be made on the assumption that an internal dimension of the case is d, the thickness of the case main body and the lid is t, the length from the farthest point from the opening inside the case to the projection TE is w1, and the length from the same point to the projection TT is w2.

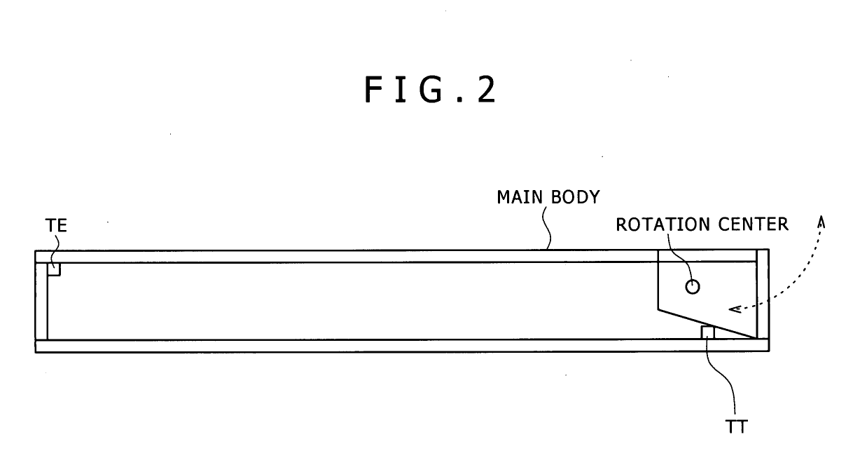

Further, FIG. 2 is a cross-sectional view of a second picture case according to the embodiment of the present invention.

The second picture case has a pocket shape having a supporting point on the side of opening. In this picture case, the projections TE and TT are provided as in the case of the first case, however, as a surface opposite to the opening (the bottom surface of the pocket) functions as a projection, the projection TE may be omitted.

In any of these picture cases, polycarbonate resin may be used as the material. Further, semi-transparent resin may be used as at least outer surfaces on which an index print area and a back cover area in the index sheet to be described later are fixed. Further, acrylic resin or the like may be used for adding a high-quality appearance to the case.

In the picture cases according to the present embodiment, the projections TE and TT are provided so as to fix the index sheet.

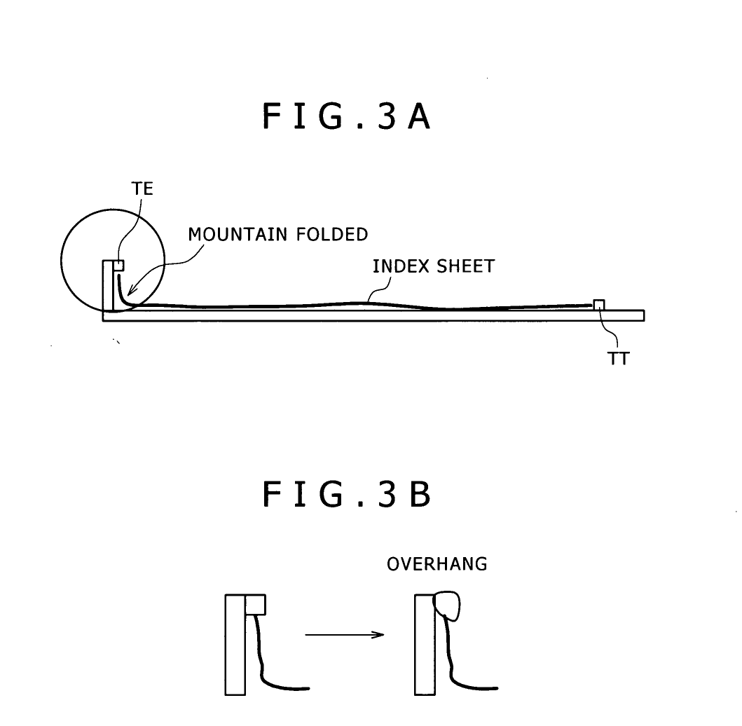

FIG. 3A shows a part of the case where the index sheet is fixed. In this figure, the other portions than a portion where the index sheet is fixed are omitted. As shown in FIG. 3A, one end of the index sheet is fixed with the projection TE, and the other end of the index sheet is fixed with the projection TT. The index sheet is mountain-folded when viewed from the outside of the case.

Note that in FIGS. 1, 2 and 3A, the projections TE and TT have a rectangular parallelepiped cross section. The advantage of this structure is that it can be easily processed, however, the shape of the projections TE and TT is not limited to this shape. FIG. 3B shows an enlarged view of a part surrounded by a circle in FIG. 3A. In FIG. 3B, an overhang type shape on the right side of the figure may be used since it prevents the index sheet from falling.

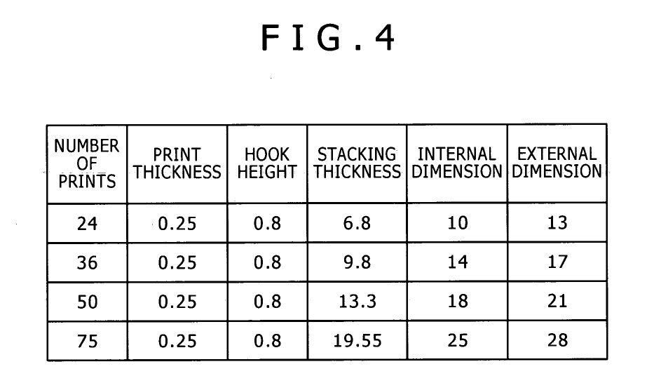

Further, as the picture case according to the embodiment, on the presumption that L-size (89 mm×127 mm) picture prints are stored, four sizes of picture cases as shown in FIG. 4 can be generated. In this example, considering that picture prints from negative films are also stored, picture cases for storing 24 prints and 36 prints are generated, and further, picture cases for storing 50 prints and 75 prints are generated. Note that the thickness of each print is 0.25 mm on the presumption that a general thick silver-chloride picture-print sheet is used. The height of the projection to fix the index sheet (hook height) is 0.8 mm for producing a margin in a stacking thickness. The stacking thickness is 6.8 mm in the 24-print case; 9.8 mm in the 36-print case; 13.3 mm in the 50-print case; and 19.55 mm in the 75-print case.

In consideration of the stacking thicknesses, the internal dimension d is 10 mm in the 24-print case; 14 mm in the 36-print case; 18 mm in the 50-print case; and 25 mm in the 75-print case. Further, as the thickness t about 1.5 mm or 2 mm gives a high-quality appearance, the thickness t is 1.5 mm. As a result, the external dimension is 13 mm in the 24-print case; 17 mm in the 36-print case; 21 mm in the 50-print case; and 28 mm in the 75-print case.

Note that the types of cases as shown in FIG. 4 are merely examples. As the storage capacity for 36 prints is close to that of the 50-print case, the 50-print case may be used for the 36-print case. In the following description, the 36-print case is not prepared but the 50-print case is used also as the 36-print case.

Further, the projections TE and TT may be formed to have a width of 1 mm and a height of 0.8 mm. The interval between the projections TE and TT (w1+w2) may be (127+α) mm for storage of L-size picture prints. That is, in the case of L-size print, the length of the index sheet to be fixed with the projections TE and TT is 127 mm, however, when the interval between the projections TE and TT is 127 mm, the index sheet cannot be fit between the projections TE and TT due to its thickness and distortion of the mountain-fold portion as shown in FIG. 3A. Therefore the interval is 127 mm plus a mm as a margin. The margin α may be about 0.5 mm.

Note that as the picture cases for 24 prints, 50 prints and 75 prints respectively have different internal dimensions, it is necessary to change the position of the projection TT in the lid in accordance with case type to set the same interval between the projections TE and TT in these cases. However, for simplification of image processing software and commonality of a mold for cover side resin, the position of the projection TT may be fixed. In this case, the length of cutting is adjusted thereby the interval is adjusted.

Further, in the present embodiment, the picture cases are prepared for storing L-size picture prints, however, the picture cases may be produced for DSC size, king size and the like by a similar method.

[Index Sheet]

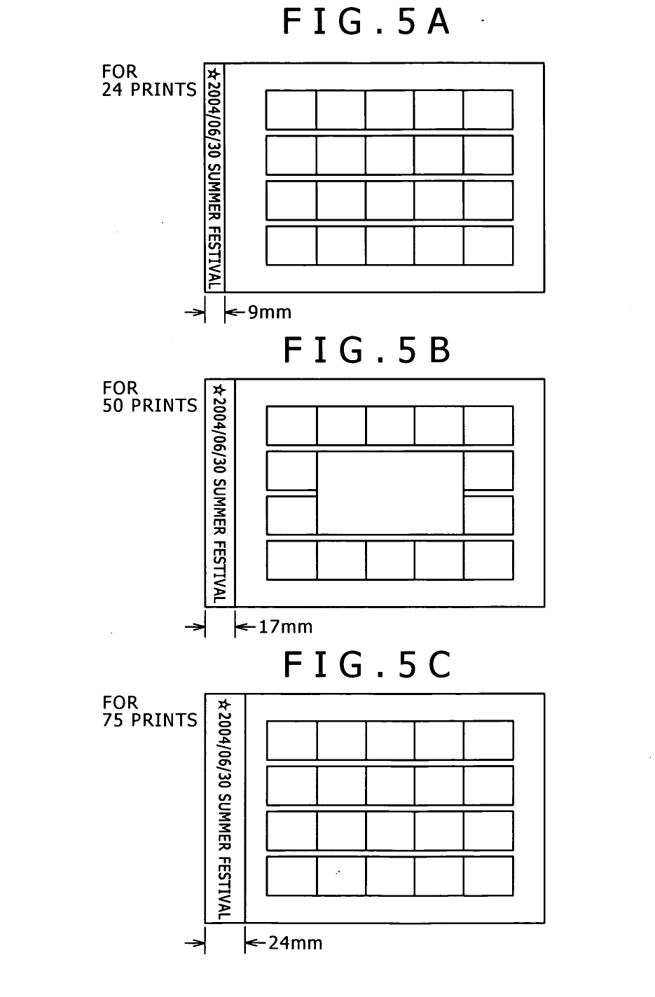

As shown in FIGS. 5A to 5C, three types of index sheets having different formats are generated for the three types of picture cases for 24 prints, 50 prints and 75 prints. That is, the width of an area where a back cover image is formed (back cover area) is different in accordance with the type of picture case. The width of the back cover area of the index sheet fitted in the 24-print picture case is 9 mm; the width of the index sheet fitted in the 50-print picture case is 17 mm; and the width of the index sheet fitted in the 75-print picture case is 24 mm.

Note that in the back cover, designated information is printed against a background in a selected color. The printed information includes a point mark and its color variation, externally-input character string and the like. Further, a date to be marked in the back cover may be extracted from information attached to a picture file.

On the other hand, in the index sheet, an area where reduced images are formed (index print area) may have an arbitrary form designated from the outside. In FIGS. 5A and 5C, a general index print where five frames of reduced images are arranged in four strips is formed. In FIG. 5B, an index print where central six frames are replaced with one representative frame is formed.

That is, in the index sheet according to the present embodiment, the back cover area and the index print area are connected via a portion folded upon attachment of the sheet to the picture case (fold line).

Note that the illustrated examples of the index sheet are attached to the picture case such that the index sheets can be seen from outside the picture case. When there are remaining pictures and their reduced images cannot be included in the index print area, the reduced images may be printed in the second and the subsequent index sheets. Since the number of pictures is not limited in image sensing by a digital camera, the number of index sheets is basically changed. Note that in the second and the subsequent index sheets, no back cover area is required.

[Image Forming Apparatus]

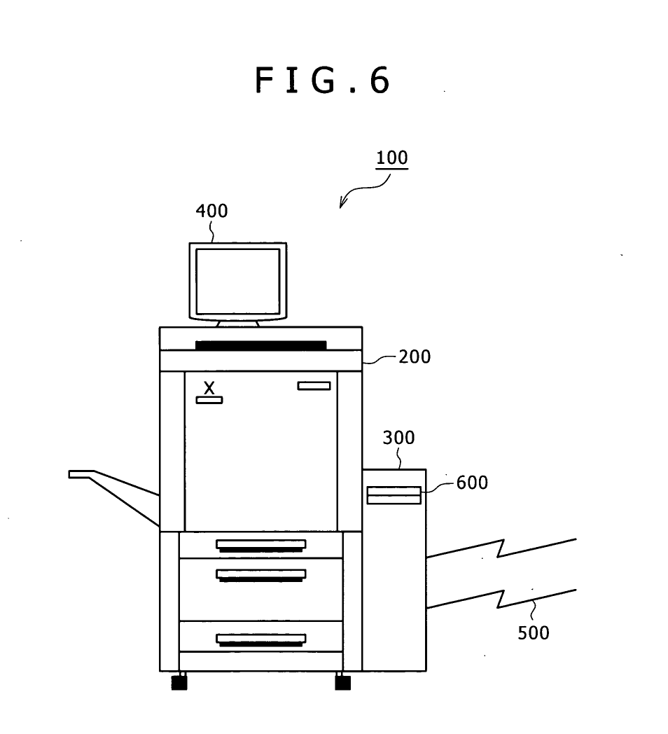

FIG. 6 shows the outer appearance of an image forming apparatus 100 to which the present embodiment is applied.

As shown in FIG. 6, the image forming apparatus 100 to which the present embodiment is applied has an apparatus main body 200 which maps and print-outputs input image data on a sheet, and an input/output unit 400 which enables a user to select various functions of the image forming apparatus 100 and which is used as an operation panel of the image forming apparatus 100. Further, the image forming apparatus 100 has a processing unit 300 which processes image data received from an external device or the like connected to the apparatus, and a communication unit 500 which functions as a communication section connected with the external device. Further, the image forming apparatus 100 is provided with a slot 600 through which portable storage media including optical disks such as various DVDs (Digital Versatile Discs) and various CDs and various memory cards can be inserted/pulled out.

The apparatus main body 200 functions as a printer which forms a toner image based on input image data and obtains a full-color print image using e.g. an electrophotographic technique. Further, the apparatus main body 200 has a scanner and also functions as a digital copier which outputs image data read by the scanner. Further, the apparatus main body 200 can function as a facsimile machine when it is connected via the communication unit 500 with a telephone line for transmission/reception of image data and outputs image data. In this manner, the apparatus main body 200 functions as a conventional multifunction machine, and further, functions as a picture printing device which photo-prints images obtained by e.g. a digital camera (including a cellular phone which functions as a digital camera). To function as the picture printing device, the apparatus main body 200 performs high image quality processing in addition to general toner image generation. Further, in the apparatus main body 200, picture print output at an equivalent level to that of picture printing using a silver chloride film is achieved by improvement in glossiness by addition of transparent toner or the like. The detailed operation of the apparatus main body 200 will be described later.

The processing unit 300, which is a computer device such as a personal computer (PC) or a server, has a drive unit to read data from various storage media.

The input/output unit 400 has a display such as a liquid crystal display (LDC). A touch panel or the like may be formed on the surface of the display such that the input/output unit 400 has an input function as a user interface. When the input/output unit 400 does not have the touch panel function, an input panel (not shown), a pointing device and the like may be provided on e.g. an upper surface of the apparatus main body 200, such that the user can perform operation input to the input/output unit 400.

The communication unit 500, having e.g. a cable, obtains information on a device connected with the cable and image data. Further, the communication unit 500 is capable of bidirectional communication to transmit a command from the processing unit 300 to the device connected with the cable. Available interface standards are USB (Universal Serial Bus), IEEE 1394 (Institute of Electrical and Electronic Engineers 1394), SCSI (Small Computer System Interface) standards and the like. Further, it may be arranged such that the communication unit 500 has only an interface connector for utilizing data transmission by these interfaces. The cable may be colored by communication function, or a tag showing the name of interface such as USB or IEEE 1394 is attached to a terminal to be connected with a device.

Next, the functional construction of the processing unit 300 will be described.

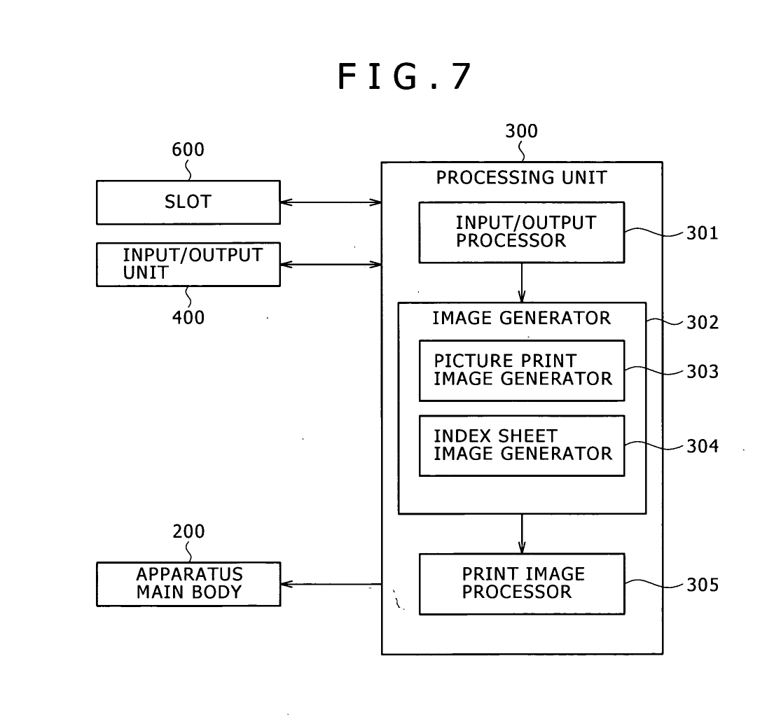

FIG. 7 is a block diagram showing the functional construction of the processing unit 300.

The processing unit 300 includes an input/output processor 301, an image generator 302, and a print image processor 305.

The input/output processor 301 inputs images from a storage medium inserted into the slot 600, inputs various information from the input/output unit 400, and displays thumbnails on the input/output unit 400. From a viewpoint that an image selected by the user is obtained as a picture print image, the input/output processor 301 can be grasped as an image acquisition unit. From a viewpoint that heading information for a picture print is obtained, the input/output processor 301 can be grasped as an information acquisition unit.

In the image generator 302, a picture print image generator 303 generates a picture print image, and an index sheet image generator 304 generates an index sheet image.

The print image processor 305 performs processing to print-output the images generated by the image generator 302 by the apparatus main body 200.

Note that these functional units are realized by co-operation between software and hardware. More particularly, a CPU of the processing unit 300 reads a program to realize the input/output processor 301, the image generator 302 (including the picture print image generator 303 and the index sheet image generator 304) and the print image processor 305 from an external storage device into a main storage device, and performs processing.

Next, the operation of image processing by the processing unit 300 will be described.

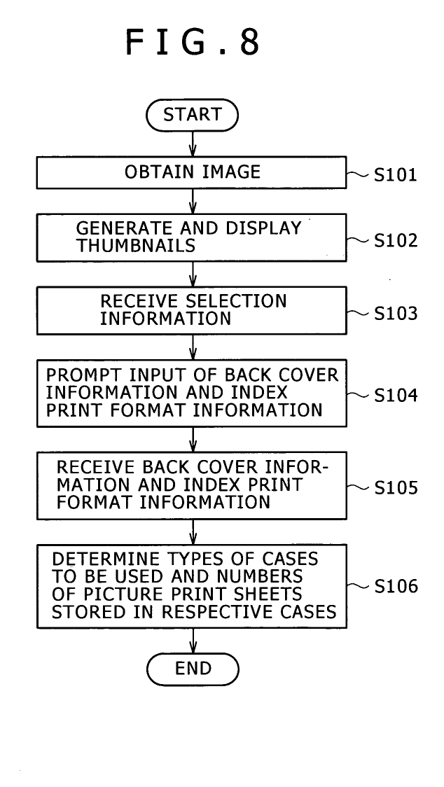

FIG. 8 is a flowchart showing the operation of the input/output processor 301.

First, the input/output processor 301 obtains images recorded on a storage medium inserted in the slot 600 (Step 101). Then, the input/output processor 301 generates thumbnails of these images and displays them on the input/output unit 400 (Step 102). Thereafter, when the user has selected thumbnails to print-output from the displayed thumbnails, the input/output processor 301 receives information to specify the selected images (selection information) (Step 103).

Next, the input/output processor 301 prompts input of information on color of a back cover, a mark, a character string and the like to be printed on the back cover (back cover information) and format information regarding the number of thumbnails included in an index print and the arrangement of the index print (index print format information) (Step 104). When the user has inputted the information from the input/output unit 400, the input/output processor 301 receives the input information (Step 105). Note that the information may be changed in correspondence with the number of images selected at Step 103, otherwise, the user may select the information.

Thereafter, the input/output processor 301 determines the types of picture cases to be used and the number of picture prints to be stored in the respective picture cases based on the number of selected images (Step 106).

Note that the determination of the types of picture cases and the number of picture prints stored in the respective picture cases at Step 106 may be arbitrarily performed. For example, it may be arranged such that a table showing correspondence between the number of selected images and the number of picture cases and the number of picture prints as their capacities is prepared, and the above determination is made by referring to the table. For example, regarding the number of selected images “76”, information for use of two 50-print picture cases, each to store 38 picture prints, is defined.

Otherwise, it may be arranged such that an optimum number of picture cases and the number of picture prints to be stored in the respective picture cases are automatically calculated in correspondence with the number of selected images.

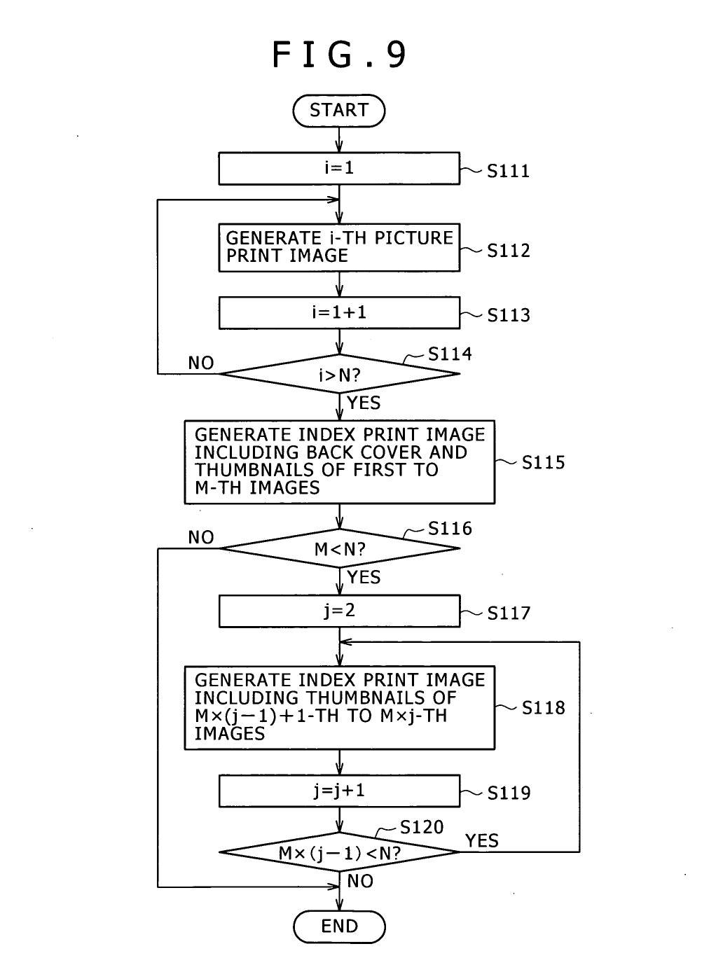

FIG. 9 is a flowchart showing the operation of the image generator 302.

The image generator 302 generates images of picture prints to be stored and generates an image of an index sheet to be stored, for each picture case. Note that the picture print images are generated by the picture print image generator 303 in the image generator 302, and the index sheet image is generated by the index sheet image generator 304 in the image generator 302.

In this example, the operation regarding one picture case will be described. For this picture case, N picture prints are to be stored, and M thumbnails are to be included in the index print area of an index sheet to be fitted in the picture case.

First, the picture print image generator 303 sets an index i indicating the number of picture print images to “1” (Step 111), and repeats processing at Steps 112 and 113 until the index i becomes N. That is, picture print images are generated by performing processing for cutting an image in a predetermined picture print size from an i-th image (trimming) or the like (Step 112), and the index i is incremented by “1” (Step 113).

At Step 114, it is determined whether or not the index i has become N. If the index i is not greater than N, the process returns to Step 112, while if the index i is greater than N, the process proceeds to Step 115 and the subsequent steps to perform index sheet image generation processing.

The index sheet image generator 304 generates a print image for the first index sheet (Step 115). More particularly, the index sheet image generator 304 generates an index sheet image including a back cover image including the back cover information received at Step 105 in FIG. 8 and thumbnails of 1st to M-th picture print images. Then, it is determined whether or not N is greater than M, i.e., whether or not an image not included in the first index sheet exists (Step 116).

As a result, if N is equal to or less than M, i.e., no image not included in the first index sheet exists, the process ends.

On the other hand, if N is greater than M, i.e., image(s) not included in the first index sheet exists, an index j indicating the number of index sheets is set to “2” (Step 117), and the processing at Steps 118 and 119 is repeated until there is no image to be included in an index sheet. That is, an index sheet print image is generated (Step 118). More particularly, an index sheet image including thumbnails of Mx(j−1)+1st to Mxj-th picture print images is generated. Note that the second and the subsequent index sheets do not have a back cover because these index sheets are not fixed so as to be seen from the outside the picture case but they are stored in the case as in the case of picture prints. Next, the index j is incremented by “1” (Step 119).

Then, it is determined at Step 120 whether or not there is no image to be included in the index sheet. If N is greater than Mx(j−1), the process returns to step S118, while if N is equal to or less than Mx(j−1), the process ends.

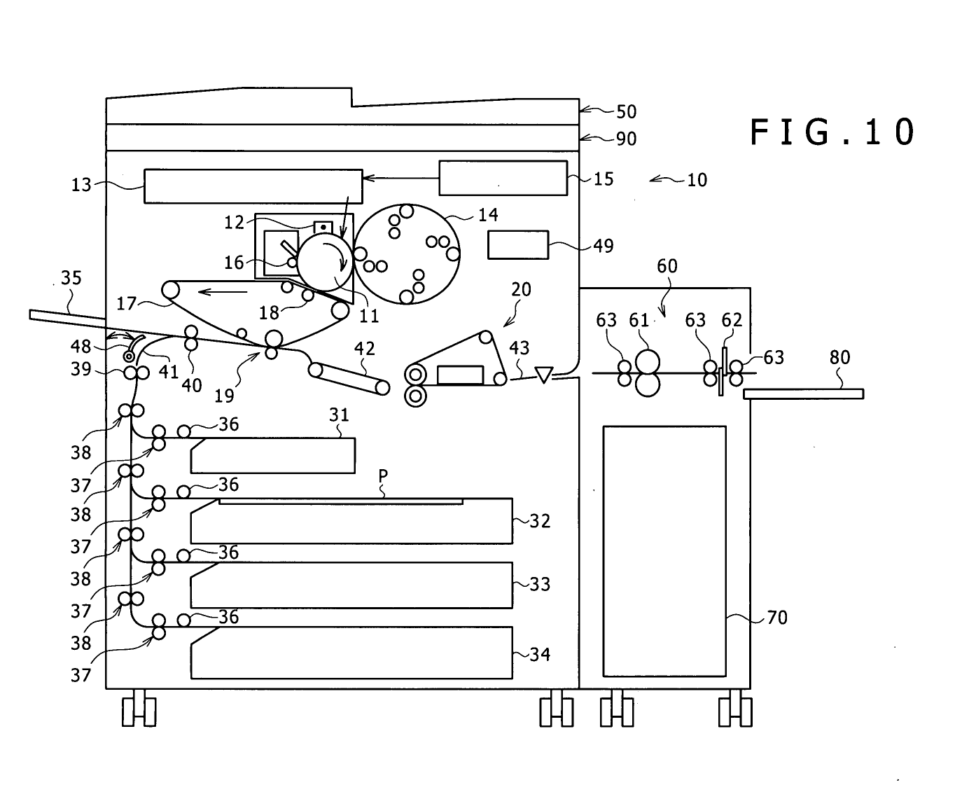

FIG. 10 is a schematic cross-sectional view of the internal structure of the apparatus main body 200 of the image forming apparatus 100 according to the present embodiment. The apparatus main body 200 has a printer main body 10 which forms an image on a recording sheet P as a recording medium, a document feeder 50 which sequentially transports documents from a stacked documents, and a scanner 90 which reads an image by scanning. Note that when the apparatus main body 200 is a printer connected to a control personal computer or a LAN (neither shown), the document feeder 50 and the scanner 90 may be omitted.

The printer main body 10 has a photoconductor drum 11 provided rotatably in an arrow direction, an intermediate transfer belt 17 provided rotatably in an arrow direction as a transfer member which sequentially transfers respective-color toner images from the photoconductor drum 11 (primary transfer) to hold the toner images, a secondary transfer unit 19 which transfers the toner images on the intermediate transfer belt 17 onto the recording sheet P as a recording medium at once (secondary transfer), and a glossiness fixing unit 20 which fixes the secondary-transferred image on the recording sheet P and adds silver-chloride picture-like glossiness to the recording sheet P.

Electronic devices such as a charger 12 to charge the photoconductor drum 11, an exposure unit 13 such as a laser scanning unit to write an electrostatic latent image on the photoconductor drum 11, a rotary developing unit 14 to which four developers including yellow (Y), magenta (M), cyan (C) and black (K) color toners to obtain visible images with the 4-color toners are rotatably attached, a primary transfer roller 18 which transfers the respective color toner images formed on the photoconductor drum 11 onto the intermediate transfer belt 17, and a drum cleaner 16 which removes remaining toner from the photoconductor drum 11 after transfer, are sequentially provided around the photoconductor drum 11. Note that the exposure unit 13 performs writing of electrostatic latent image on the photoconductor drum 11 based on a digital image signal inputted from an image processor (IPS) 15.

Next, a sheet transport system will be described. The sheet transport system has plural (4 in the present embodiment) sheet trays 31 to 34 to hold recording sheets P and a manual feed tray 35 for manually supplying the recording sheets P from the outside of the printer main body 10. Further, in the respective sheet trays 31 to 34, a lead-in roller (Najjar roller) 36 to become into contact with the stacked recording sheets P and pick a sheet up from an upper surface of the stacked sheets is provided in an upper part, a sheet control roller 37 including a supply roller and a control roller to supply recording sheets P one by one is provided on the downstream side of the roller 36, and a take-away roller 38 to temporarily stop the recording sheet P then re-transmit the recording sheet P at predetermined timing is provided on the downstream side of the sheet control roller 37. When the recording sheets P are supplied from the lower sheet trays 32 to 34, the take-away roller 38 functions as a transport roller to simply transport the recording sheets P to a sheet passage.

A sheet passage 41 on the downstream side of the take-away roller 38 is provided with a pre-registration roller 39 to transport a document to a further downstream side roller and perform loop formation, and a registration roller 40 to temporarily stop and then restart rotation at predetermined timing, to supply the recording sheet P while performing registration adjustment on the secondary transfer unit 19. Further, a transport belt 42 is provided on the downstream side of the sheet passage 41. The recording sheet P where an unfixed image has been transferred is transported by the transport belt 42 to the glossiness fixing unit 20. Further, the sheet passage 41 is provided with a baffle 48 which rotates about a supporting point in correspondence with a loop state of the transported recording sheets P.

Further, in the present embodiment, the sheet transport system is provided with a cutter unit 60 as a cutting member.

The cutter unit 60 has a slitter 61 which cuts the recording sheet P along its transport direction, a reciprocating cutter 62 which cuts the recording sheet P in a direction orthogonal to the transport direction, and a transport roller 63 which transports the recording sheet P. Further, the cutter unit 60 has a wastepaper box 70 to collect wastepaper caused by cutting by the cutter unit 60, and further, has a exit tray 80 on which the recording sheets P after cutting by the cutter unit 60 are stacked.

Note that a controller 49, which controls supply and transport of the recording sheet P, document supply and transport in the document feeder 50, a scanning operation in the scanner 90 and the like as well as various controls upon image formation, is provided in the printer main body 10.

Next, the operation of the image forming apparatus will be described.

The controller 49 executes a predetermined image forming operation when an image signal has been inputted from the scanner 90, a personal computer (not shown) or the like. First, the photoconductor drum 11 is rotate-driven, and the surface of the photoconductor drum 11 is charged to a predetermined potential by the charger 12. Next, an electrostatic latent image corresponding to the image is written by the exposure unit 13 based on the image write signal outputted from the image processor 15, and the electrostatic latent image is developed by a developer of a color corresponding to the image in the rotary developing unit 14. For example, when the electrostatic latent image written on the photoconductor drum 11 corresponds to yellow, the electrostatic latent image is developed by a yellow developer containing yellow toner, and a yellow toner image is formed on the photoconductor drum 11. The toner image formed on the photoconductor drum 11 is primary-transferred from the photoconductor drum 11 onto the intermediate transfer belt 17 by a primary transfer bias applied to the primary transfer roller 18 in a primary transfer position where the photoconductor drum 11 and the intermediate transfer belt 17 come into contact. On the other hand, toner remaining on the photoconductor drum 11 after the primary transfer is removed by the drum cleaner 16.

At this time, if a monochrome image is formed, the toner image primary-transferred onto the intermediate transfer belt 17 is immediately secondary-transferred onto a sheet. However, if a color image where plural color toner images are overlaid is formed, the toner image formation on the photoconductor drum 11 and the primary transfer of the toner image from the photoconductor drum 11 are repeated in correspondence with the number of colors. For example, when a full-color image where 4-color toner images are overlaid is formed, yellow, magenta, cyan and black toner images are sequentially formed on the photoconductor drum 11, and the respective color toner images are sequentially primary-transferred onto the intermediate transfer belt 17. On the other hand, the intermediate transfer belt 17, holding the primary-transferred toner image, rotates in the same cycle of the rotation of the photoconductor drum 11. Then, the magenta, cyan and black toner images are transferred onto the intermediate transfer belt 17 by one rotation.

In this manner, the toner image primary-transferred onto the intermediate transfer belt 17 is transported to a secondary transfer position in accordance with the rotation of the intermediate transfer belt 17. On the other hand, the recording sheet P, automatically selected in accordance with the user's designation or obtained input image data, is supplied by the registration roller 40 at timing of arrival, at the secondary transfer unit 19, of the toner image on the photoconductor drum 11. For example, when the tray 31 has been selected, the recording sheet P, taken out by the lead-in roller 36 and supplied as one sheet by the sheet control roller 37, is transported by the take-away roller 38, and its orientation is corrected by the pre-registration roller 39 via the sheet passage 41, then supplied by the registration roller 40 to the secondary transfer unit 19. In the secondary transfer unit 19, the toner image held on the intermediate transfer belt 17 is transferred onto the recording sheet P. Thereafter, the recording sheet P where the toner image has been transferred is sent to the glossiness fixing unit 20, and subjected to heat-press fusing and cool-down separation. Then the recording sheet P is discharged via a sheet discharge passage 43 to the cutter unit 60.

In the cutter unit 60, the slitter 61 cuts the recording sheet P in its transport direction. More particularly, an upper blade of the slitter 61 is rotated by a motor (not shown) in e.g. a counter-clockwise direction in FIG. 10. On the other hand, a lower blade of the slitter 61 is fixed. As the recording sheet P is transported, the upper blade is rotated and the upper blade is sequentially pressed against the lower blade, thereby the recording sheet P is cut in the transport direction. Further, wastepaper caused in this cutting is stored in the wastepaper box 70.

Next, the reciprocating cutter 62 cuts the recording sheet P in a direction orthogonal to the transport direction. More particularly, the position of the image is detected by a sensor, then a portion to be cut is aligned immediately below the reciprocating cutter 62, and the recording sheet P is cut by the operation of the reciprocating cutter 62. Also in this case, wastepaper caused in the cutting is stored in the wastepaper box 70.

Thereafter, output matters cut out from the recording sheet P are discharged to the exit tray 80.

Note that in the present embodiment, an electrophotographic printer is utilized, however, any of sublimational, silver chloride and ink-jet printers may be employed as long as it is capable of digital printing.

[Form of Use]

In the above description, the operator of the image forming apparatus 100 is simply expressed as a user. Next, a description will be given of a form of business in which a customer to perform picture printing at a photo studio or the like outputs an index sheet and a salesclerk of the photo studio or the like puts the index sheet in a picture case and hands the case to the customer.

First, the customer inputs images from a storage medium into the image forming apparatus 100, then, considering color coding of the family or the like, inputs back cover information from a touch panel or a keyboard. When picture prints and an index sheet have been completed, the salesclerk mountain-folds the index sheet, and fits the sheet in a predetermined sized picture case. At this time, the index sheet tends to run off because the paper of the index sheet is elastic, however, the index sheet can be fixed with concave and convex stoppers inside the case. Further, the salesclerk puts the picture prints in the picture case. When the salesclerk hands the case to the customer, the salesclerk lets the customer check the index sheet. The customer checks the index sheet to recognize his/her picture prints and receives the picture case. The customer brings the picture case, then show his/her family the picture prints in the case. Thereafter, the customer places the case on a shelf where such cases are classified in accordance with back covers and the like.

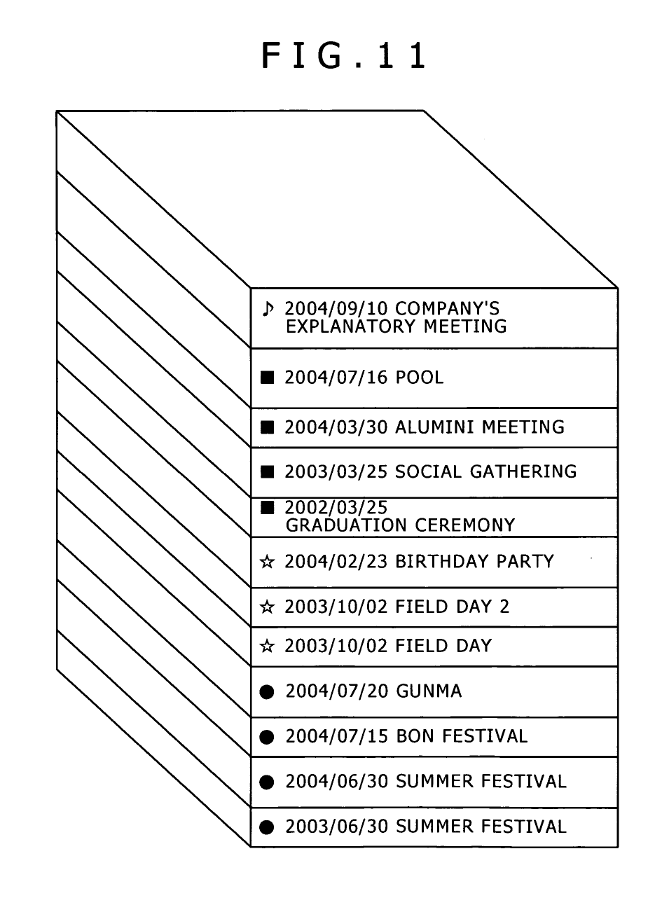

In the present embodiment, ten resin picture cases having an external width of 13 mm, ten resin picture cases having an external width of 21 mm and ten resin picture cases having an external width of 28 mm (total 30 cases) each having a length of 132 mm and a width of 94 mm are prepared, and a display pattern to be displayed on a back cover is selected from four patterns. As shown in FIG. 11, when the picture cases are placed on a bookshelf, they are arranged compactly and in good order, and further, a search can be easily made. Note that in FIG. 11, the picture cases are stacked flat, however, they may be stood on the bookshelf.

[Modification]

In the above embodiment, the processing unit 300 as a part of the image forming apparatus 100 performs image processing to generate an index sheet image, however, the present invention is not limited to this arrangement. For example, a personal computer or the like connected via a LAN or the like to the image forming apparatus 100 may perform similar image processing.

Further, the index sheet is not limited to those as shown in FIGS. 5A to 5C but various forms may be employed. For example, a back cover portion is provided at the center of the index sheet and index print portions are provided on both sides of the back cover portion. In the case of this index sheet, when it is put in the picture case, the index print functions both as a front cover and as a back cover. Further, it may be arranged such that an image to assemble a paper picture case is outputted. In this case, an index print image and a back cover image are formed on the outer surface of the paper.

As described above, in the present embodiment, an index sheet is fitted in a picture case and fixed to an outermost surface of the case. The index sheet includes a back cover portion as well as an index print portion. Accordingly, picture prints stored in the picture case can be checked, and a search for a picture case containing picture prints can be easily made.

Further, in the picture case, at least surfaces on which the back cover portion and the index print portion are fixed are transparent or semi-transparent, and projections to fix the index sheet are provided. In this arrangement, the index sheet is merely mountain-folded and fitted in the picture case, then the picture case can be handed to a customer.

Further, as classification identification information in the back cover portion can be designated upon picture printing, a customer can generate a back cover for various classifications by his/her preference, and this is helpful in the future arrangement and searching.

As described above, according to an embodiment of the present invention, a back cover portion (heading area) and an index print portion (index print area) are formed on an index sheet such that the heading in the heading area functions as a back cover. That is, provided is an index sheet used for checking picture prints included in a particular picture print group, having: an index print area in which plural picture print images included in the particular picture print group are formed; and a heading area sharing a fold line with the index print area, in which a heading image for the particular picture print group is formed.

According to second embodiment of the present invention, a picture case for containing picture prints has: at least five surfaces including a first surface and a second surface adjacent to the first surface; and an index sheet having an index print area where original images of the picture prints are formed and a heading area to display heading information for the picture prints, wherein the index sheet is attached so as to cause the index print area to be recognizable from a direction vertical to the first surface and to cause the heading area to be recognizable from a direction vertical to the second surface.

According to third embodiment of the present invention, an image processing apparatus for generating an index sheet image used for checking a picture print includes: an image acquisition unit that acquires plural picture images; an information acquisition unit that acquires heading information for the plural picture images; and an index sheet image generation unit that generates an index sheet image having a heading, by combining an index print image including a predetermined number of images selected from the plural picture images acquired by the image acquisition unit with a heading image including the heading information acquired by the information acquisition unit so as to arrange the index print image and the heading image in positions holding a fold line therebetween.

According to fourth embodiment of the present invention, an image processing method for generating an index sheet image used for checking picture prints includes: acquiring plural picture images; acquiring heading information for the plural picture images; and generating an index sheet image by combining an index print image including the plural picture images with a heading image including the heading information so as to arrange the index print image and the heading image in positions holding a fold line therebetween.

According to fifth embodiment of the present invention, a storage medium storing a program for realizing a predetermined function by a computerstores a program of instructions executable by the computer performs a function including: acquiring plural picture images; acquiring heading information for the plural picture images; and generating an index sheet image by combining an index print image including the plural picture images with a heading image including the heading information so as to arrange the index print image and the heading image in positions holding a fold line therebetween.

According to an aspect of the present invention, picture prints may be easily organized, and a search may be easily performed on the organized picture prints later.

While this invention has been described in connection with certain embodiments, it is to be understood that the subject matter encompassed by way of this invention is not to be limited to those specific embodiments. On the contrary, it is intended for the subject matter of the invention to include all alternative, modification and equivalents as can be included within the spirit and scope of the following claims.

The entire disclosure of Japanese Patent Application No. 2005-067603 filed on Mar. 10, 2005 including specification, claims, drawings and abstract is incorporated herein by reference in its entirety.

What is claimed is:

1. An index sheet used for checking picture prints included in a particular picture print group, comprising:
an index print area in which a plurality of picture print images included in the particular picture print group are formed; and
a heading area sharing a fold line with the index print area, in which a heading image for the particular picture print group is formed.

2. The index sheet according to claim 1, wherein the heading image includes at least one of an externally-input character string and a symbol, the externally-input character string and the symbol regarding the particular picture print group.

3. The index sheet according to claim 1, surrounded by a first side, a second side, a third side, a forth side, the first side and the second side opposed each other, the third side and the forth side opposed each other and contacting with the first side and the second side,
wherein the index print area is a rectangular area surrounded by the first side, the third side, the fourth side and the fold line, and
the heading area is a rectangular area surrounded by the second side, the third side, the fourth side and the fold line.

4. A picture case for storing picture prints, comprising:
at least five surfaces including a first surface and a second surface adjacent to the first surface; and
an index sheet having an index print area where original images of the picture prints are formed and a heading area to display heading informations for the picture prints,
wherein the index sheet is attached so as to cause the index print area to be recognizable from a direction vertical to the first surface and to cause the heading area to be recognizable from a direction vertical to the second surface.

5. The picture case according to claim 4, wherein the first surface and the second surface are formed with a transparent material, and a projection to fix the index sheet is provided inside the case.

6. An image processing apparatus for generating an index sheet image used for checking picture prints, comprising:
an image acquisition unit that acquires a plurality of picture images;
an information acquisition unit that acquires heading information for the plurality of picture images; and
an index sheet image generation unit that generates an index sheet image having a heading by combining an index print image with a heading image so that the index print image and the heading image hold a fold line therebetween, the index print image including a predetermined number of images selected from the plurality of picture images acquired by the image acquisition unit, the heading image including the heading information acquired by the information acquisition unit.

7. The image processing apparatus according to claim 6, wherein the index sheet image generation unit determines a size of the heading image in correspondence with the number of picture prints of which the images have been acquired by the image acquisition unit.

8. The image processing apparatus according to claim 6, wherein the index sheet image generation unit further generates an index sheet image without a heading which includes picture images excluded from the index sheet image having a heading, and which is not combined with the heading image.

9. An image processing method for generating an index sheet image used for checking picture prints, comprising:
acquiring a plurality of picture images;
acquiring heading informations for the plurality of picture images; and
generating an index sheet image by combining an index print image including the plurality of picture images with a heading image including the heading information so that the index print image and the heading image hold a fold line therebetween.

10. A storage medium readable by a computer, the storage medium storing a program of instructions executable by the computer to perform a function comprising:
acquiring a plurality of picture images;
acquiring heading informations for the plurality of picture images; and
generating an index sheet image by combining an index print image including the plurality of picture images with a heading image including the heading information so that the index print image and the heading image hold a fold line there between.

11. The image processing apparatus according to claim 6, wherein the index sheet image generation unit determines a size of the heading image in correspondence with the number of the index print image.
